(19) United States
(12) Patent Application Publication
(10) Pub. No.: US 2012/0157896 A1
(43) Pub. Date: Jun. 21, 2012

(54) MASSAGE DEVICE

(75) Inventors: Minoru Kawamoto, Shiga-ken (JP); Noboru Nishiguchi, Shiga-ken (JP); Hiroyuki Inoue, Shiga-ken (JP); Takeshi Izunaka, Osaka (JP)

(73) Assignee: Panasonic Corporation, Osaka (JP)

(21) Appl. No.: 13/392,760

(22) PCT Filed: Sep. 2, 2010
(86) PCT No.: PCT/JP2010/065008

§ 371 Date: Feb. 27, 2012

(30) Foreign Application Priority Data
Sep. 25, 2009 (JP) 2009-220462

(51) Int. Cl. A61H 9/00

(52) U.S. Cl. 601/148

(57) ABSTRACT

A massage device (10) includes a seat (12), a backrest (13), and an ottoman (14). Airbags (23), which serve as massage means, are provided on one side of the ottoman (14). A leg placing portion (14c), on which legs of a user can be placed, is provided on the other side, which is the opposite side. The ottoman (14) is rotatably supported by a rotary shaft (16a), which extends in a lateral direction. The ottoman (14) is selectively switched between a massage capable state and a leg placing state by rotating the ottoman (14). The ottoman (14) includes a leg rest (14a) and a foot rest (14b). The foot rest (14b) is formed to rotate independently. The foot rest (14b) has urging members (31). The urging members (31) urge the distal end of the foot rest (14b) that is at the front in the massage capable state toward the rotary shaft (16a) by a predetermined force.

### TECHNICAL FIELD

The present invention relates to a massage device capable of massaging the legs of a user.

### BACKGROUND ART

Conventionally, a massage device has been proposed that includes a tiltable ottoman in front of a seat on which a user can be seated. The ottoman includes an airbag that is selectively inflated and deflated to massage the legs of a user (for example, see Patent Document 1).

Also, the ottoman provided in the massage device of Patent Document 1 includes a leg rest that has a pair of recesses into which the legs of the user can be inserted independently as shown in FIG. 3 of the publication. Airbags are included in side walls of each recess. In a state where the legs are inserted in the recesses, the airbags are inflated and deflated so that the legs of the user are separately massaged.

In such a massage device, it is necessary to place relatively large airbags in the side walls of the recesses to sandwich the legs of the user by the airbags. Therefore, the side walls extend forward of the seat by a great amount. Thus, in the case where the airbags are not used to massage, the side walls of the recesses become obstructions when the user sits on the seat of the massage device. Therefore, in the massage device of Patent Document 1, the ottoman is reversed, or rotated, so that the recesses are stored and the back surface of the ottoman is used as, for example, a leg placing portion as shown in FIG. 4.

### PRIOR ART DOCUMENT

### Patent Document

Patent Document 1: Japanese Patent No. 3508771

### SUMMARY OF THE INVENTION

### Problems that the Invention is to Solve

In the case with the ottoman including the leg rest that massages only the legs like the above-mentioned massage device, the size of the ottoman as a whole is relatively small. Thus, it is easy to reverse the ottoman.

However, according to the ottomans included in the massage devices in recent years, a foot rest is provided separately from the leg rest in addition to the leg rest. The foot rest has support recesses that can support feet of the user from, for example, soles. In this case, the size of the ottoman as a whole is increased, and it is difficult to reverse the entire ottoman.

Accordingly, it is an objective of the present invention to provide a massage device in which an ottoman is easily reversed.

### Means for Solving the Problems

In accordance with one aspect of the present invention, a massage device is provided. The massage device includes a seat on which a user can be seated, an ottoman located in front of the seat and on which legs of the user can be placed, and massage means provided on the ottoman. The massage means massages the legs of the user. The massage device is characterized by the following features. The ottoman includes, on a first side, a leg rest having recesses in which the legs of the user can be inserted and a foot rest having recesses that supports feet of the user from soles. The massage means is provided in at least either of the recesses of the leg rest and the recesses of the foot rest. The ottoman includes, on a second side, a leg placing portion on which the legs of the user can be placed. The ottoman is rotatably supported by a rotary shaft, which extends in a lateral direction with respect to a pair of support portions provided on the seat. By rotating the ottoman, the ottoman is switched between a massage capable state, in which the recesses are exposed to the front of the seat, and a leg placing state, in which the leg placing portion is exposed to the front of the seat. The foot rest is supported to be rotatable with respect to the legs. The foot rest includes urging means that urges the distal end of the foot rest that is on the front side in the massage capable state toward the rotary shaft by a predetermined urging force.

The foot rest is preferably rotated between a stored position, at which the foot rest is drawn toward the rotary shaft, and an extended position opposite to the stored position, and the urging means preferably exerts force to keep both the stored position and the extended position.

A gap is preferably provided between the foot rest and the leg placing portion to prevent interference between the foot rest and the leg placing portion when the foot rest is rotated. The gap is closed by a flexible cover member. The cover member is preferably put in a tension state when the foot rest is urged toward the rotary shaft by the urging means.

The massage means is preferably formed by an airbag that is selectively inflated and deflated.

Each recess of the foot rest preferably includes a bottom portion that supports the corresponding foot of the user, and sole massage means that selectively presses the sole is provided on the bottom portion.

### BRIEF DESCRIPTION OF THE DRAWINGS

FIG. 1 is a schematic side view illustrating a massage device according to one embodiment of the present invention;

FIG. 2 is a side view illustrating the massage device of FIG. 1 in which the ottoman is in a leg placing state;

FIGS. 3(a) and 3(b) are side views illustrating the operation of the urging member;

FIG. 4 is a front view illustrating the ottoman;

FIG. 5 a side view illustrating the ottoman; and

FIGS. 6(a) and 6(b) are side views for explaining the cover member.

### MODES FOR CARRYING OUT THE INVENTION

A massage device according to one embodiment of the present invention will now be described with reference to the drawings.

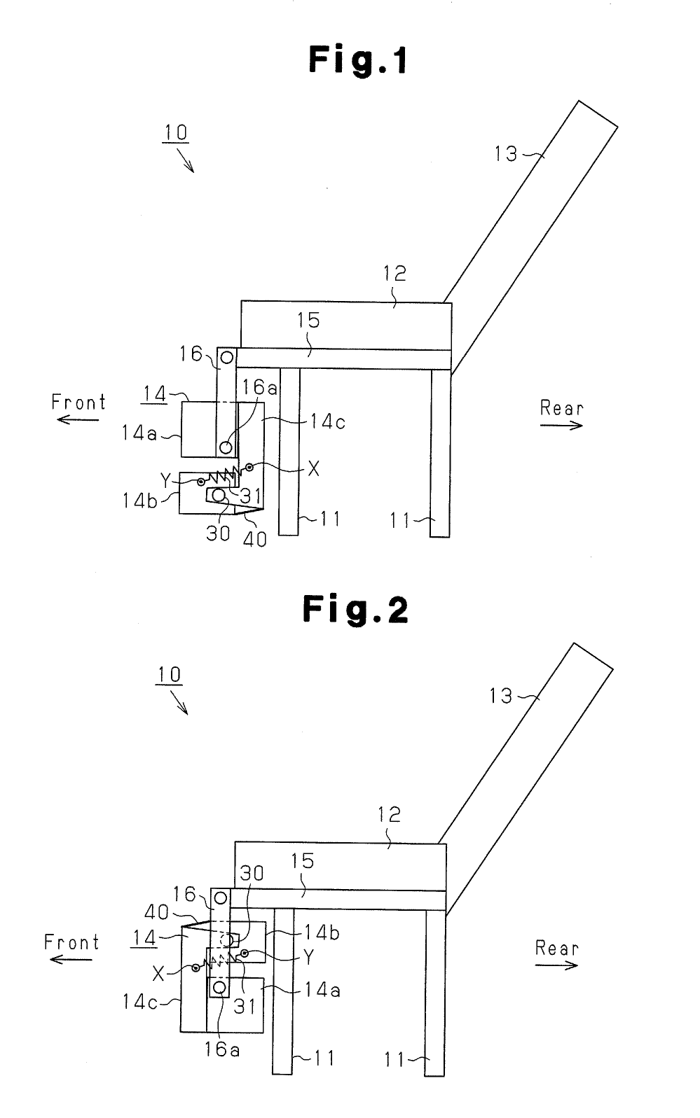

FIG. 1 is a schematic side view illustrating a massage device of the present embodiment. The massage device 10 includes legs 11, a seat 12, a backrest 13, and an ottoman 14. The legs 11 are located on a floor surface, which is not shown. The seat 12 on which a user can be seated is provided on the legs 11.

The backrest 13 is provided on the rear part of the seat 12 to be tiltable with respect to the seat 12. The ottoman 14 is provided on the front part of the seat 12 to be tiltable with respect to the seat 12. Also, a pair of frames 15 (only one is shown in FIG. 1) is provided on the seat 12 to extend between the rear part and the front part of the seat 12. The proximal ends of support frames 16 are connected to the front ends of the frames 15. The support frames 16 extend in the vertical direction. The ottoman 14 is rotatably mounted on the distal ends of the support frames 16 with a support shaft 16a, which extends in the lateral direction of the seat 12 (the direction perpendicular to the sheet of FIG. 1).

The ottoman 14 includes a leg rest 14a and a foot rest 14b. The leg rest 14a is connected to the distal ends of the support frames 16, and includes a pair of recesses 14e into which legs (calves) of a user seated in the seat 12 can be inserted. The foot rest 14b includes a pair of recesses 14f on which the feet of the user are placed and supported. Also, on the other side of the ottoman 14 from the leg rest 14a and the foot rest 14b, a substantially planar leg placing portion 14c on which the legs of the user can be placed is provided. Therefore, in the massage device 10 of the present embodiment, by rotating the ottoman 14 about the support shaft 16a, the ottoman 14 can be shifted between a massage capable state (see FIG. 1) and a leg placing state (see FIG. 2). In the massage capable state, airbags 23, 28, 29 (see FIG. 4), which serve as massage means and are provided in the recesses 14e, 14f, are exposed on the front surface of the massage device 10. Accordingly, it becomes possible to massage the user. In the leg placing state, the leg placing portion 14c is exposed on the front surface of the massage device 10. Thus, the user's legs can be placed on the leg placing portion 14c.

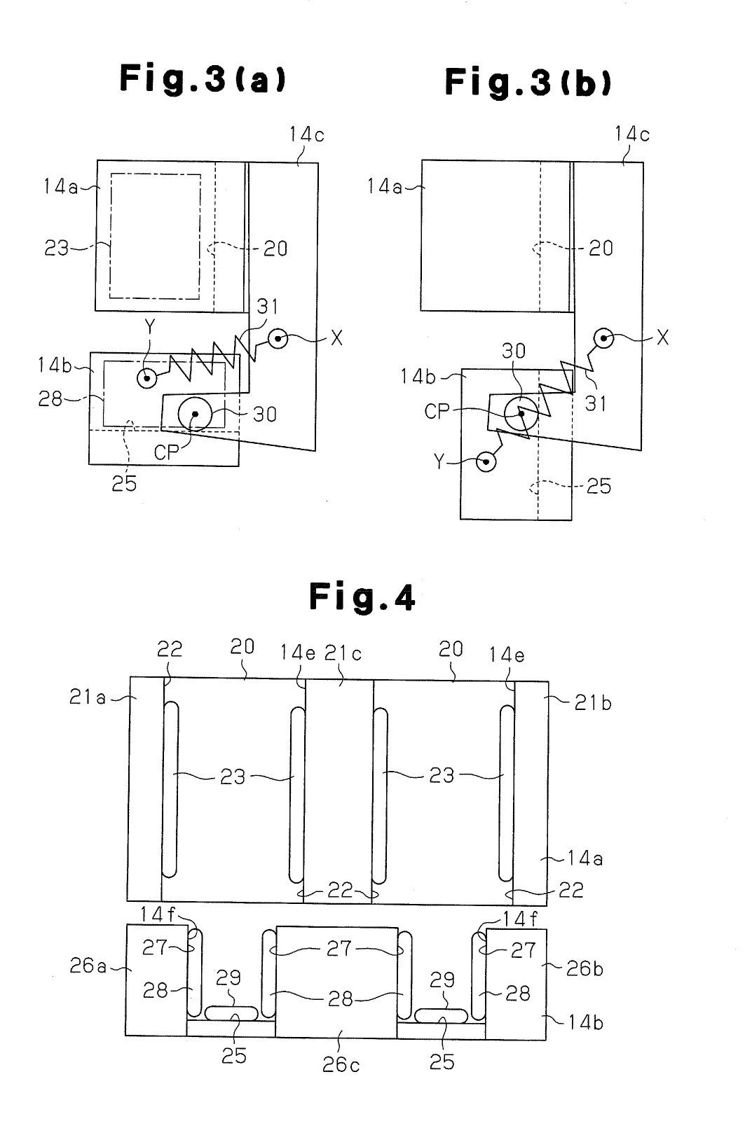

The leg rest 14a includes three side walls 21a to 21c, which extend in substantially the same direction on both edges and at the center of the leg rest 14a as shown in FIGS. 3(a) and 4. Each recess 14e is defined by a bottom portion 20 and a pair of inner surfaces 22 of the side walls 21a to 21c. The airbag 23, which serves as the massage means, is provided on each inner surface 22.

The foot rest 14b includes three side walls 26a to 26c, which extend in substantially the same direction on both edges and at the center of the foot rest 14b. Each recess 14f is defined by a bottom portion 25 and a pair of inner surfaces 27 of the side walls 26a to 26c. The airbag 28, which serves as the massage means, is provided on each inner surface 27. Furthermore, sole massage means, which is the airbag 29 in this embodiment, is provided on the bottom portion 25 of each recess 14f.

The foot rest 14b is supported to be rotational with respect to the leg rest 14a about the support shaft 30. An urging member 31 such as a spring is provided on both sides of the foot rest 14b. The distal end portion of the foot rest 14b (left side in FIG. 1) is constantly urged toward the leg rest 14a (the support shaft 16a) by the urging members 31. More specifically, one end of each urging member 31 is fixed to a fixing point X on the corresponding side surface of the leg placing portion 14c. The fixing point X is located at a position higher than a fixing point Y on the distal end portion of the foot rest 14b. Therefore, the distal end portion of the foot rest 14b is urged toward the support shaft 16a about the support shaft 30.

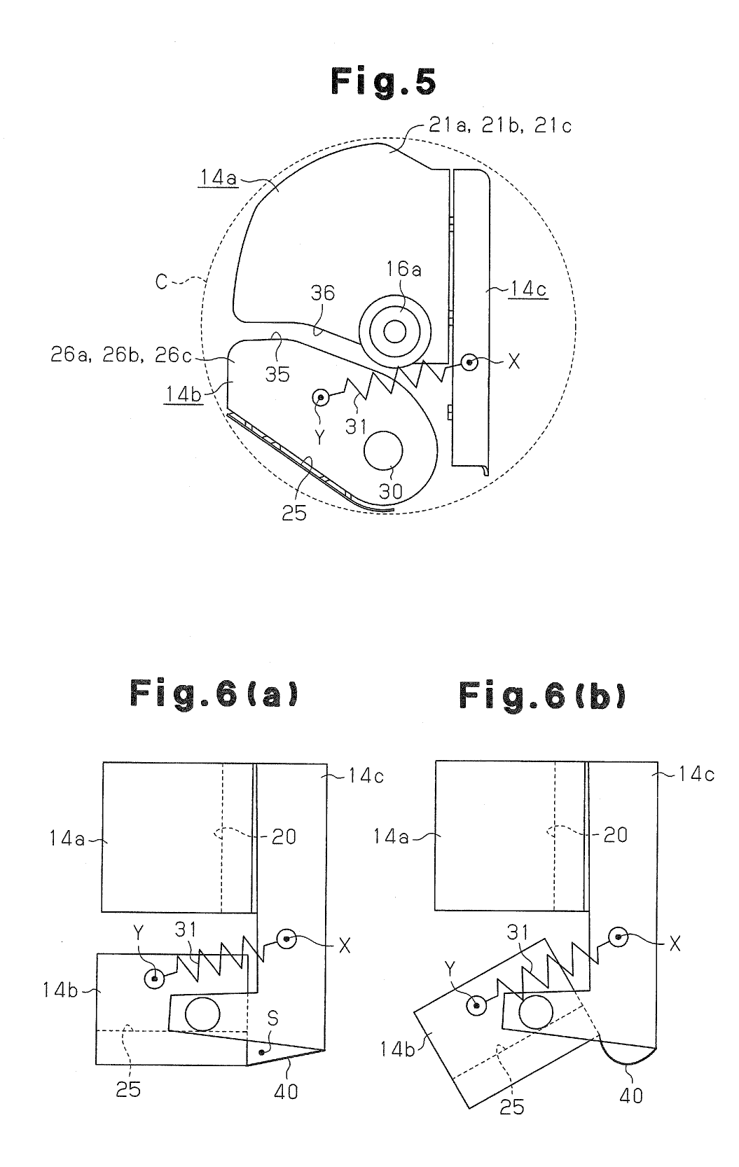

Also, for example, when the legs and the feet of the user are not placed on the recesses 14e, 14f of the ottoman 14, the foot rest 14b is arranged at a stored position at which the foot rest 14b is urged by the urging members 31 toward the support shaft 16a as shown in FIG. 5. At this time, end surfaces 35 of the side walls 26a to 26c of the foot rest 14b face end surfaces 36 of the side walls 21a to 21c of the leg rest 14a. The end surfaces 35, 36 are formed such that the distances between each end surface 35 and the corresponding end surface 36 are substantially equal. Therefore, the size of the entire ottoman 14 is reduced, which permits the ottoman 14 to be rotated in a suitable manner. At this time, the foot rest 14b is urged by the urging members 31 to the position where the angle between the bottom portion 25 of the foot rest 14b and the bottom portion 20 of the leg rest 14a is substantially 55 degrees such that the foot rest 14b is stored in an imaginary circle C having a predetermined radius. The imaginary circle C has, for example, a radius that is half the distance from the floor surface (not shown) to the lower surface of the seat 12. Accordingly, while the size of the ottoman 14 is maximized, the floor surface and the lower surface of the seat 12 and the ottoman 14 are prevented from interfering each other when rotating the ottoman 14.

If the force toward the support shaft 16a is greater than the urging force of the urging members 31, the distal end portion of the foot rest 14b is rotated in the direction opposite to the leg rest 14a about the support shaft 30. As shown in FIG. 3(a), when a straight line (not shown) connecting the fixing points X, Y of the urging member 31 exceeds the center point CP of the support shaft 30, the urging member 31 urges the foot rest 14b in the direction opposite to the support shaft 16a (the distal end portion of the foot rest 14b is urged downward in FIG. 3(b)). Accordingly, the foot rest 14b is arranged in an extended position. In the extended position, the foot rest 14b is fixed such that the bottom portion 20 of the leg rest 14a is substantially parallel to the bottom portion 25 of the foot rest 14b. Therefore, for example, the massage device accommodates users with long legs. Furthermore, the airbags 23, 28 of the leg rest 14a and the foot rest 14b can massage from the legs to the ankles of the user.

The foot rest 14b is formed separately from the leg placing portion 14c to permit the foot rest 14b to rotate. As shown in FIG. 6(a), a gap S is provided between the foot rest 14b and the leg placing portion 14c. In the massage device 10 of the present embodiment, a cover member 40 is provided on the lower surface of the bottom portion 25 of the foot rest 14b and a longitudinal end surface of the leg placing portion 14c to close the gap S as shown in FIGS. 6(a) and 6(b). The cover member 40 is formed of a stretchable and flexible material. Also, when the foot rest 14b is urged to the stored position, the cover member 40 is pulled by the urging member 31 into a tension state. Since the cover member 40 that closes the gap S is provided as described above, foreign objects are prevented from entering the gap S.

In the ottoman 14 of the massage device 10 formed as described above, a non-illustrated air pump is controlled so that the airbags 23, 28, 29 inflate and deflate as required in response to supply and exhaust of air through the air pump. Accordingly, the legs and the feet of the user are massaged. Furthermore, according to the massage device 10 of the present embodiment, the airbags 23, 28, 29, which serve as the massage means in this embodiment, are provided on one side of the ottoman 14, and the planar leg placing portion 14c is provided on the other side. The ottoman 14 is formed to be rotational. Therefore, the user can select whether to use the ottoman 14 as massage equipment, or as the leg placing portion 14c depending on the user's mood.

Also, the size of the ottoman 14 as a whole is reduced by urging the distal end portion of the foot rest 14b toward the leg rest 14a with the urging members 31, and the ottoman 14 can be rotated easily.

The present embodiment has the following advantages.

(1) The foot rest 14b is formed to rotate independently. Also, the foot rest 14b has the urging members 31. The urging members 31 urge the distal end portion of the foot rest 14b that is at the front in the massage capable state toward the support shaft 16a by a predetermined urging force. In this manner, the size of the ottoman 14 as a whole is reduced by urging the distal end portion of the rotational foot rest 14b toward the support shaft 16a by a predetermined urging force with the urging members 31, and the ottoman 14 can be rotated easily.

(2) The airbags 29, which serve as the massage means, are provided on the bottom portions 25 of the foot rest 14b, which support the feet of the user from the soles. In the case where the airbags 29 are inflated, if force acts on the rotational foot rest 14b in the direction opposite to the direction in which the user's soles are pressed, it is difficult to massage in a suitable manner. At this time, since the foot rest 14b is urged toward the support shaft 16a by the urging members 31 in the present configuration, the opposite force as described above is reduced, and it is possible to massage in a suitable manner.

(3) The foot rest 14b rotates between the stored position, at which the foot rest 14b is drawn toward the support shaft 16a, and the extended position opposite to the stored position. The urging members 31 are configured to exert urging force to keep the two positions, which are the stored position and the extended position. Therefore, by arranging the airbags on the bottom portions 25 of the foot rest 14b as the massage means, for example, the soles can be massaged in the state where the distal end portion of the foot rest 14b is urged toward the support shaft 16a. Furthermore, by arranging the foot rest 14b at the extended position, the ankles of the user can be massaged. In other words, the distal end portion of the foot rest 14b is urged toward the opposite side from the direction toward the support shaft 16a. The side walls 26a to 26c are arranged on the foot rest 14b to extend along the user's ankles in the urged state. The pair of airbags 28, which serve as the massage means, sandwich each ankle of the user. The ankles of the user are massaged by inflating and deflating the airbags 28.

(4) The gap S is provided between the foot rest 14b and the leg placing portion 14c to prevent interference between the foot rest 14b and the leg placing portion 14c when rotating. The gap S is closed by the flexible cover member 40. The cover member 40 is put in the tension state when the foot rest 14b is urged toward the support shaft 16a by the urging members 31. As described above, in the present configuration in which the foot rest 14b can be independently rotated, the predetermined gap S is provided between the leg placing portion 14c and the foot rest 14b not to interfere with each other when rotating the foot rest 14b. Thus, by closing the gap S by the cover member 40, foreign objects are prevented from entering the gap S. Furthermore, the cover member 40 is formed of a flexible material. Also, the foot rest 14b is urged toward the support shaft 16a by the urging members 31 so that the cover member 40 is put in the tension state. This prevents the cover member 40 from becoming wrinkled.

(5) The massage means is formed by the airbags 23, 28, 29, which selectively inflate and deflate. Thus, the user can be softly massaged.

(6) The airbags 23, 28, 29, which serve as the massage means, are provided on one side of the ottoman 14. The leg placing portion 14c, on which the user's legs can be placed, is provided on the other side, which is the opposite side of the ottoman 14. The ottoman 14 is rotatably supported by the laterally extending support shaft 16a. By rotating the ottoman 14, the ottoman 14 is selectively switched between the massage capable state and the leg placing state. By rotating the ottoman 14, the ottoman 14 is switched to the massage capable state when massaging, and is switched to the leg placing state where the user's legs can be placed when not massaging. Since the state of the ottoman 14 can be selected depending on the mood of the user at different times, the convenience of the ottoman 14 is enhanced.

(8) Also, the side walls 21a to 21c, 26a to 26c, which extend from the bottom portions 20, 25 of the recesses 14e, 14f, need to be formed so that, when arranging the airbags 23, 28, which serves as the massage means, on the ottoman 14, the airbags 23, 28 can sandwich the legs and the feet of the user from the side surfaces. Therefore, in the conventional massage device, when the user does not require massage on the legs in the massage capable state, the side walls 21a to 21c, 26a to 26c of the recesses 14e, 14f become obstructions when the user is seated. Therefore, as in the present configuration, the leg placing portion 14c is formed to be planar without having recesses. This facilitates the user to be seated, and the convenience of the ottoman 14 is enhanced.

The embodiment of the present invention may be modified as follows.

In the above described embodiment, the cover member 40 is formed of a flexible material such as a stretching material. Instead, the cover member may be formed of other materials. Alternatively, the cover member may be omitted.

In the above described embodiment, the airbags 29, which serve as the sole massage means, are provided on the bottom portions 25 of the recesses 14e, but the airbags 29 may be omitted.

In the above described embodiment, the airbags 23, 28, 29, which serve as the massage means, are provided in both the recesses 14e and the recesses 14f. However, the massage means (airbags) may be provided in only either of the recesses 14e and the recesses 14bf.

In the above described embodiment, although not particularly mentioned, for example, a massage mechanism that massages the upper body of the user may be provided in the massage device 10. The massage mechanism includes a treatment element and provided in the backrest 13.

In the above described embodiment, the backrest 13 is tiltable with respect to the seat 12. Instead, the backrest 13 does not need to be tiltable, that is, the backrest 13 may be fixed. Alternatively, the backrest 13 may be omitted.

### DESCRIPTION OF THE REFERENCE NUMERALS

10 . . . Massage Device
11 . . . Legs
12 . . . Seat
14 . . . Ottoman
14a . . . Leg Rest
14b . . . Foot Rest
14c . . . Leg Placing Portion
16 . . . Support Frames (Support Portions)
16a . . . Support Shaft
20, 25 . . . Bottom Portions
23, 28, 29 . . . Airbags (Massage Means)
31 . . . Urging Members (Urging Means)
40 . . . Cover Member
S . . . Gap

1. A massage device comprising:
a seat on which a user can be seated;
an ottoman located in front of the seat and on which legs of the user can be placed; and
massager provided on the ottoman, the massager massaging the legs of the user, wherein,
the ottoman includes, on a first side, a leg rest having recesses in which the legs of the user can be inserted and a foot rest having recesses that supports feet of the user from soles, the massager being provided in at least either of the recesses of the leg rest and the recesses of the foot rest, and the ottoman includes, on a second side, a leg placing portion on which the legs of the user can be placed,
the ottoman is rotatably supported by a rotary shaft, which extends in a lateral direction with respect to a pair of support portions provided on the seat, wherein, by rotating the ottoman, the ottoman is switched between a massage capable state, in which the recesses are exposed to the front of the seat, and a leg placing state, in which the leg placing portion is exposed to the front of the seat, and
the foot rest is supported to be rotatable with respect to the legs, the foot rest including urging member that urges the distal end of the foot rest that is on the front side in the massage capable state toward the rotary shaft by a predetermined urging force.

2. The massage device according to claim 1, wherein,
the foot rest is rotated between a stored position, at which the foot rest is drawn toward the rotary shaft, and an extended position opposite to the stored position, and
the urging member exerts force to keep both the stored position and the extended position.

3. The massage device according to claim 1, wherein,
a gap is provided between the foot rest and the leg placing portion to prevent interference between the foot rest and the leg placing portion when the foot rest is rotated,
the gap is closed by a flexible cover member, and
the cover member is put in a tension state when the foot rest is urged toward the rotary shaft by the urging member.

4. The massage device according to claim 1, wherein,
the massager is formed by an airbag that is selectively inflated and deflated.

5. The massage device according to claim 1, wherein,
each recess of the foot rest includes a bottom portion that supports the corresponding foot of the user, and sole massager that selectively presses the sole is provided on the bottom portion.
